(19) United States
(12) Patent Application Publication
(10) Pub. No.: US 2014/0348416 A1
(43) Pub. Date: Nov. 27, 2014

(54) STEREO IMAGE RECTIFICATION APPARATUS AND METHOD

(71) Applicant: HIMAX MEDIA SOLUTIONS, INC., Tainan City (TW)

(72) Inventor: Kun-Hsien Lee, Tainan City (TW)

(73) Assignee: HIMAX MEDIA SOLUTIONS, INC., Tainan City (TW)

(21) Appl. No.: 13/901,056

(22) Filed: May 23, 2013

(51) Int. Cl. G06T 19/20

(52) U.S. Cl. CPC G06T 19/20
USPC 382/154

(57) ABSTRACT

A stereo image rectification apparatus includes: an input unit, for receiving a first image from a first camera and a second image from a second camera, wherein the first and the second camera are affine cameras; a feature point determination unit, for determining at least one first feature point on the first image and at least one second feature point on the second image, wherein both the first feature point on the first image and the second feature point on the second image correspond to the same imaginary object; and a warping matrix establishing unit, for establishing a warping matrix for mapping the first image to the second image by: calculating the elements of the warping matrix in regard to the mapping between the x- and y-coordinates of the first feature points and the y-coordinates of the second feature points

### BACKGROUND OF THE INVENTION

1. Field of the Invention

The present invention relates to image processing technology, and in particular to stereo image rectification technology.

2. Description of the Related Art

FIG. 1A shows a set of affine cameras (stereoscopic cameras). The set of affine cameras has two cameras for recording images from two perspectives, thereby creating the illusion of depth. As shown in FIG. 1A, there is usually a displacement between the two cameras. In addition, the two cameras are sometimes rotated in relation to each other as shown in FIG. 1B. FIG. 2A shows the scan lines for searching the depth for two corresponding feature points on a respective right and left image obtained from the two cameras. As shown in FIG. 2A, due to the displacement and the rotation described above, it is difficult for the corresponding feature points (for example, points P and P′ in FIG. 2A) to locate on the same scan line. The error rate in searching the depth may thus seriously increase.

A warping matrix is often used to remap feature points from one image to the other. With the warping matrix, the corresponding feature points on the two images can be calibrated to be on the same scan line, as shown in FIG. 2B. In the prior art, before obtaining the warping matrix, it is required to establish a fundamental matrix based on the plurality of feature points (for example, n feature points). Specifically, one should firstly establish an n×9 matrix A that contains coordinates of the n feature points, which is shown as follows:

$$A = [ \begin{matrix}{x}_{l 1} {x}_{r 1} & {y}_{l 1} {x}_{r 1} & {x}_{r 1} & {x}_{l 1} {y}_{r 1} & {y}_{l 1} {y}_{r 1} & {y}_{r 1} & {x}_{r 1} & {y}_{l 1} & 1 \\ {x}_{l 2} {x}_{r 2} & {y}_{l 2} {x}_{r 2} & {x}_{r 2} & {x}_{l 2} {y}_{r 2} & {y}_{l 2} {y}_{r 2} & {y}_{r 2} & {x}_{l 2} & {y}_{l 2} & 1 \\ ⋮ & ⋮ & ⋮ & ⋮ & ⋮ & ⋮ & ⋮ & ⋮ & ⋮ \\ {x}_{ln} {x}_{rn} & {y}_{ln} {x}_{rn} & {x}_{rn} & {x}_{ln} {y}_{rn} & {y}_{ln} {y}_{rn} & {y}_{rn} & {x}_{ln} & {y}_{ln} & 1\end{matrix} ] ;$$

then multiply the matrix A with its transpose A^{T} to obtain an 9×9 matrix; and finally performing the single value decomposition (SVD) on the 9×9 matrix to obtain the fundamental matrix and further the warping matrix.

However, this computational procedure gets more and more complex as the number of the feature points increases. In addition, since this manner requires extensive use of multiplexers, it is almost impossible to be implemented by the hardware.

### BRIEF SUMMARY OF THE INVENTION

The present invention provides a stereo image rectification apparatus, comprises: an input unit, for receiving a first image from a first camera and a second image from a second camera, wherein the first and the second camera are affine cameras; a feature point determination unit, coupled to the input unit, for determining at least one first feature point on the first image and at least one second feature point on the second image, wherein both the first feature point on the first image and the second feature point on the second image correspond to the same imaginary object; and a warping matrix establishing unit, coupled to the feature point determination unit, for establishing a warping matrix for mapping the first image to the second image by: calculating the elements of the warping matrix in regard to the mapping between the x- and y-coordinates of the first feature points and the y-coordinates of the second feature points.

The present invention also provides a stereo image rectification method, comprising the steps of: receiving a first image from a first camera and a second image from a second camera, wherein the first and the second cameras are affine cameras; determining at least one first feature point on the first image and at least one second feature point on the second image, wherein both the first feature point on the first image and the second feature point on the second image correspond to the same imaginary object; and establishing a warping matrix for mapping the first image to the second image by: calculating the elements of the warping matrix in regard to the mapping between the x- and y-coordinates of the first feature points and the y-coordinates of the second feature points.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A and 1B show a set of affine cameras.

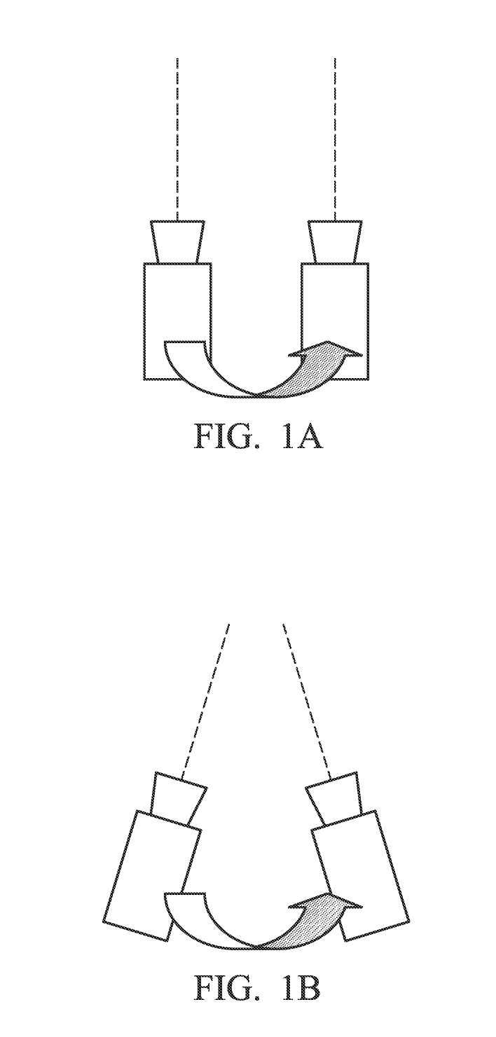

FIGS. 2A and 2B show the scan lines for searching the depth for two corresponding feature points on a respective right and left image.

FIG. 3 is a stereo image rectification apparatus according to an embodiment of the present invention.

FIG. 4 is a flowchart of a stereo image rectification method according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

To overcome the defects in the prior art, the present invention provides a stereo image rectification apparatus and a stereo image rectification method, which will be described in the following in accordance with the drawings.

### Stereo Image Rectification Apparatus

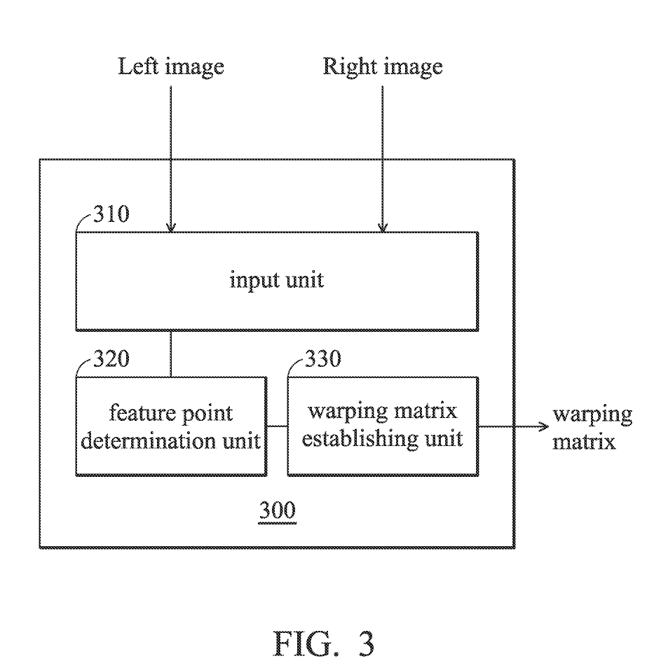

FIG. 3 is a stereo image rectification apparatus according to an embodiment of the present invention. The stereo image rectification apparatus 300 is used to calibrate the respective corresponding feature points on images to be on the same scan line. The stereo image rectification apparatus 300 comprises an input unit 310, a feature point determination unit 320, and a warping matrix establishing unit 330.

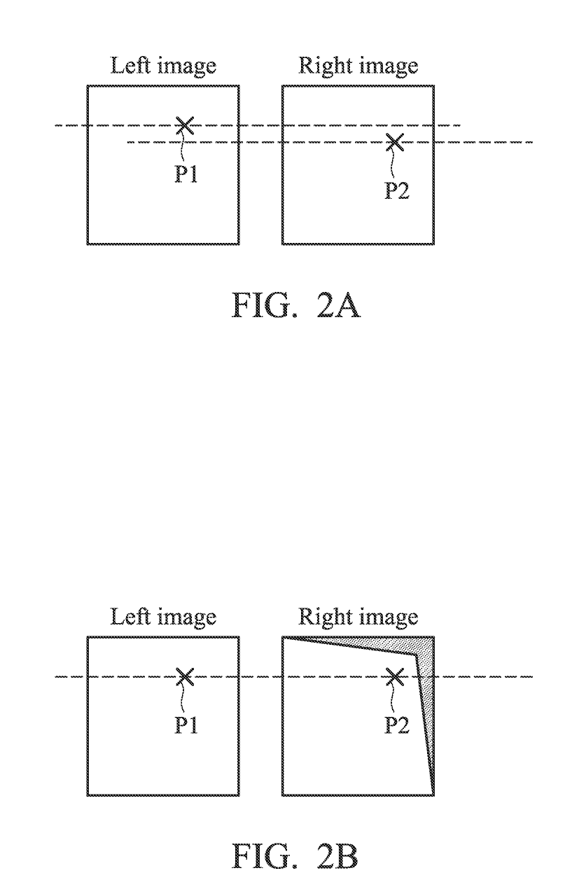

Please refer to FIGS. 2A and 3. The input unit 310 is used to receive a first image from a first camera and a second image from a second camera, where the first and second cameras are affine cameras. In some embodiments, there is displacement and rotation between the first camera and the second camera. The feature point determination unit 320 is used to determine at least one first feature point on the first image (e.g., the point P1 in FIG. 2A) and at least one second feature point on the second image (e.g., the point P2 in FIG. 2A), wherein the first and second feature points P1 and P2 correspond to the same imaginary object (not shown). Technology related to the determination of the feature points can be referred to Szeliski, R. (2010). Computer Vision: Algorithms and Applications, USA, Springer. The warping matrix establishing unit 330 is used to establish a warping matrix. The warping matrix can map the first image to the second image based on the feature points, thus defining the relationship therebetween. The warping matrix is shown as follows:

$$[ \begin{matrix}x 2 \\ y 2 \\ 1\end{matrix} ] = [ \begin{matrix}m 0 & m 1 & t 0 \\ m 3 & m 4 & t 1 \\ 0 & 0 & 1\end{matrix} ] [ \begin{matrix}x 1 \\ y 1 \\ 1\end{matrix} ]$$

Where the symbols “x1” and “y1” respectively represent the x- and y-coordinates of the feature point P1; and the symbols “x2” and “y2” respectively represent the x- and y-coordinates of the feature point P2. In addition, the symbols “m0, m1 and t0” are the elements of the warping matrix in regard to the mapping between the x- and y-coordinates of the first feature point P1 and the “x-coordinate” of the second feature point P2; and the symbols “m3, m4 and t1” are the elements of the warping matrix in regard to the mapping between the x- and y-coordinates of the first feature points P1 and the “y-coordinate” of the second feature points P2. Note that the x- and y-coordinates of the feature points P1 and P2 hereinafter mean the horizontal and vertical positions thereof, and, since the first and the second cameras are affine cameras, the corresponding feature points P1 and P2 have the same depth position (i.e., the same z-coordinate).

In the present invention, to improve computational efficiency, the warping matrix is established according to the following rules: (1) ignoring the elements of the warping matrix in regard to the mapping between the x- and y-coordinates of the first feature points and the x-coordinates of the second feature points; and (2) calculating the elements of the warping matrix in regard to the mapping between the x- and y-coordinates of the first feature points and the y-coordinates of the second feature points. In this embodiment, the elements “m0, m1 and t0” are ignored and respectively given values of “1, 0, and 0”. Then, the present invention focuses on the calculation of the elements “m3, m4 and t1”, in order to make the corresponding feature points on two different images have the same y-coordinates. Specifically, the elements “m3, m4 and t1” can be calculated as follows:

$$[ \begin{matrix}y 12 \\ ⋮ \\ yn 2\end{matrix} ] = [ \begin{matrix}x 11 & y 11 & 1 \\ ⋮ & ⋮ & ⋮ \\ xn 1 & yn 1 & 1\end{matrix} ] [ \begin{matrix}m 3 \\ m 4 \\ t 1\end{matrix} ] ,$$

where the matrix

$$b = [ \begin{matrix}y 12 \\ ⋮ \\ yn 2\end{matrix} ] ;$$

the matrix

$$A = [ \begin{matrix}x 11 & y 11 & 1 \\ ⋮ & ⋮ & ⋮ \\ xn 1 & yn 1 & 1\end{matrix} ] ;$$

and the matrix

$$x = [ \begin{matrix}m 3 \\ m 4 \\ t 1\end{matrix} ] .$$

The computational procedure can be seen as an over-determined issue, and the matrix

$$x = [ \begin{matrix}m 3 \\ m 4 \\ t 1\end{matrix} ]$$

can be easily solved using the following equation:

x=(A^{T}A)⁻¹A^{T}b.

The stereo image rectification apparatus of the present invention can easily calibrate stereo images without using the single value decomposition (SVD) technique, thus greatly improving computational efficiency.

### Stereo Image Rectification Method

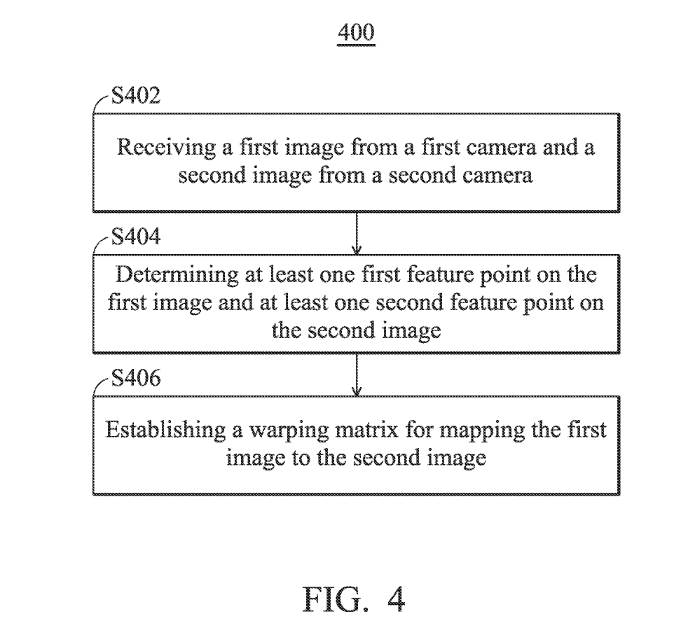

In addition to the stereo image rectification apparatus, the present invention also provides a stereo image rectification method. FIG. 4 is a flowchart of a stereo image rectification method according to an embodiment of the present invention. The stereo image rectification method 400 comprises: in step S402, receiving a first image from a first camera and a second image from a second camera, wherein the first and the second cameras are affine cameras; in step S404, determining at least one first feature point on the first image and at least one second feature point on the second image, wherein both the first feature point on the first image and the second feature point on the second image correspond to the same imaginary object; and in step S406, establishing a warping matrix for mapping the first image to the second image by: (1) ignoring the elements of the warping matrix in regard to the mapping between the x- and y-coordinates of the first feature points and the x-coordinates of the second feature points, and (2) calculating the elements of the warping matrix in regard to the mapping between the x- and y-coordinates of the first feature points and the y-coordinates of the second feature points. Since those skilled in the art can embody the stereo image rectification method of the present invention by referring to the stereo image rectification apparatus described above, its details will not be further discussed here.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A stereo image rectification apparatus, comprises:
an input unit, for receiving a first image from a first camera and a second image from a second camera, wherein the first and the second camera are affine cameras;
a feature point determination unit, coupled to the input unit, for determining at least one first feature point on the first image and at least one second feature point on the second image, wherein both the first feature point on the first image and the second feature point on the second image correspond to the same imaginary object; and
a warping matrix establishing unit, coupled to the feature point determination unit, for establishing a warping matrix for mapping the first image to the second image by:
calculating the elements of the warping matrix in regard to the mapping between the x- and y-coordinates of the first feature points and the y-coordinates of the second feature points.

2. The stereo image rectification apparatus as claimed in claim 1, wherein the warping matrix is established further by ignoring the elements of the warping matrix in regard to the mapping between the x- and y-coordinates of the first feature points and x-coordinates of the second feature points.

3. A stereo image rectification method, comprising the steps of:
receiving a first image from a first camera and a second image from a second camera, wherein the first and the second cameras are affine cameras;
determining at least one first feature point on the first image and at least one second feature point on the second image, wherein both the first feature point on the first image and the second feature point on the second image correspond to the same imaginary object; and
establishing a warping matrix for mapping the first image to the second image by:
calculating the elements of the warping matrix in regard to the mapping between the x- and y-coordinates of the first feature points and the y-coordinates of the second feature points.

4. The stereo image rectification method as claimed in claim 3, wherein the warping matrix is established further by ignoring the elements of the warping matrix in regard to the mapping between the x- and y-coordinates of the first feature points and x-coordinates of the second feature points.
